(19) United States
(12) Patent Application Publication
(10) Pub. No.: US 2026/0127719 A1
(43) Pub. Date: May 7, 2026

(54) 3D-CONSISTENT IMAGE INPAINTING WITH DIFFUSION MODELS

(71) Applicant: Naver Corporation, Gyeonggi-do (KR)

(72) Inventors: Boris Chidlovskii, Meylan (FR); Leonid Antsfeld, Saint Ismier (FR)

(73) Assignee: Naver Corporation, Gyeonggi-do (KR)

(21) Appl. No.: 18/937,788

(22) Filed: Nov. 5, 2024

(51) Int. Cl. G06T 5/70; G06T 5/77; G06T 7/11; G06T 9/00

(52) U.S. Cl. CPC G06T 5/70; G06T 5/77; G06T 7/11; G06T 9/00; G06T 2207/20182

(57) ABSTRACT

The present disclosure relates to image editing or inpainting techniques leveraging a generator model conditionally trained on one or more in-context images during a reverse diffusion process. The generator model performs inpainting of an image at inference by accessing a set of images varying in context that depicts a same or similar scene. A masked version of the image may be generated by obscuring portions of the image using a masking technique. After masking, a noisy image may be generated by iteratively introducing noise to the masked version of the image based on a noise schedule. The noisy image may act as a starting point for the subsequent reverse process leveraging the generator model configured to receive an iterated version of the image and the one or more in-context images. Based on the generator model, a transformed version of the image may be generated by iteratively denoising the noisy image.

### BACKGROUND

Image inpainting is a digital image processing technique that refers to reconstructing or filling in missing, damaged or distorted parts of an image for restoring image to a visually plausible state such that the inpainted areas look seamless and natural. The inpainting techniques may find application in various fields, including photo editing, image restoration, object removal and forensic analysis, where recovery or preservation of visual integrity may be a concern. The inpainting process may involve masking specific portions of the image, designating areas for restoration where the reconstruction of content is to be performed. Regardless of the technique used, successful inpainting may involve semantic consistency and visually harmony of the generated or reconstructed content with the surrounding elements of the image. Therefore, inpainting techniques may analyze the surrounding pixel information, predicting what the obscured content should look like to reconstruct the damaged portions of the image. However, without sufficient contextual understanding, the reconstruction may suffer from inaccuracies, leading to visually inconsistent results or artifacts that may disrupt the overall coherence of the image.

Additionally, inpainting techniques may face several other challenges, particularly when masking results in occluding significant portions of an image. Models that are trained on specific types of masks may exhibit limited generalization capabilities when given different masking configurations, which can hinder their effectiveness in real-world applications. Achieving three-dimensional (3D) consistency and a natural blend in the inpainted regions with the surrounding pixels may be a concern, particularly in images with intricate details or textures. Inpainting techniques may often face difficulties in grasping the contextual and semantic information of a scene, which can result in unrealistic outcomes. Similarly, each environment setting may present particular visual cues and spatial relationships and may account for depth and geometry to produce realistic results that influence effective inpainting. For example, variations in training datasets comprising different environments, such as indoor and outdoor scenes may complicate the inpainting process. Models trained on particular contexts, environment settings or mask distributions may encounter difficulties in generalization when faced with unfamiliar scenarios, potentially leading to suboptimal inpainting performance.

### SUMMARY

Certain aspects and features of the present disclosure relate to image inpainting techniques leveraging a denoising diffusion probabilistic model (DDPM)-referred to herein as generator model-trained by conditioning on one or more in-context images. The generator model may utilize a diffusion process that encompasses a forward diffusion process, which may incrementally add noise to a base image over multiple timesteps, and a reverse diffusion process, in which the generator model may learn to iteratively denoise the base image by taking guidance from the visible content provided by the one or more in-context images. During inference, the generator model may perform inpainting of an image by accessing a set of images including one or more in-context images. Each image of the set of images may depict a same or similar scene with variation in contexts such as camera poses, camera angles, time of the day, weather conditions or other dynamics. A masked version of the image may be generated by obscuring or removing one or more portions of the image by applying a masking technique.

After masking, a noisy image may be generated in the forward diffusion process by iteratively introducing noise to the masked version of the image based on a noise schedule. The noise schedule may comprise of the multiple timesteps where at each timestep, an amount of the noise to be added (or a noise variance) may be determined. For example, the noise may be added to the masked version of the image in gradual timesteps that are defined by the noise schedule until a completely noisy image is obtained. The noise may be sampled from various noise distributions including a Gaussian, Laplace, or uniform distribution. In one aspect of the present disclosure, Gaussian noise distribution is used for generating the noisy image. The noisy or fully noisy image may act as a starting point for the subsequent reverse diffusion process that leverages the generator model configured to receive an iterated version of the image and the one or more in-context images. Based on the noise schedule, a transformed version of the image may be generated during the reverse diffusion process by iteratively denoising the noisy image using the generator model. The transformed image may be output depicting a denoised and inpainted version of the image, where the one or more masked portions are reconstructed to align seamlessly with the surrounding non-masked areas.

In some aspects of the present disclosure, the noise schedule may modulate a frequency of the timesteps (i.e., number of timesteps) during the denoising based on an importance sampling technique. This sampling technique may dynamically allocate the amount of noise at specific timesteps (or sampling jumps) based on predefined criteria involving the previous performance of the generated images. For example, instead of a fixed noise schedule that gradually increases-such as linear or cosine, the noise schedule can change the amount of noise at specific timesteps based on criteria such as assessing the evaluation metrics (e.g., peak signal to-noise-ratio) or measuring smoothness of intermediate representations (or iterated versions of the image). In some instances, the noise schedule may be generated from a Laplace distribution.

In some examples, each image of the set of images may be independently segmented into a set of patches before passing to the generator model. The patches may be equally sized and non-overlapping. The generator model may comprise a diffusion vision transformer (DViT) encoder, also termed herein as an encoder including one or more encoder-transformers, each comprising a self-attention layer, a multilayer perceptron layer (MLP) and additional components such as normalization layers and residual connections. The encoder-transformers may be configured to generate an encoded representation by processing a set of patches associated with the noisy image. The encoder may generate one or more encoded representations by processing sets of patches associated with the one or more in-context images, where the encoder shares weights across the noisy image and the one or more in-context images. The generator model may further include a DVIT decoder, also termed herein as decoder comprising one or more decoder-transformers including the self-attention layer and a cross-attention layer. The decoder may be configured to process the encoded representations associated with the noisy image and the one or more in-context images to generate the iterated version of the image.

The masking technique may include random masking that may obscure one or more portions of the image in a random manner such that it may not cover entire objects; or semantic masking that obscures one or more portions of the image that are predicted to correspond to any of one or more types of predefined depictions e.g., pedestrians, vehicles.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The present disclosure is described in conjunction with the appended figures:

FIG. 1 shows an exemplary block diagram illustrating an aspect of the disclosed image inpainting techniques leveraging one or more in-context images within a diffusion process.

FIG. 2A shows an exemplary network illustrating a training process of a generator model, conditioned on the one or more in-context images.

FIG. 2B shows an exemplary network illustrating an inference process of the generator model, conditioned on the one or more in-context images.

FIG. 3 illustrates an exemplary block diagram of a diffusion vision transformer (DViT) encoder from the FIG. 2A.

FIG. 4 illustrates an exemplary block diagram of a diffusion vision transformer (DVIT) decoder from the FIG. 2A.

FIG. 5 schematically illustrates an example architecture of a computing system that can implement at least one example of, as disclosed, image inpainting techniques.

FIG. 6 illustrates an exemplary workflow of the image inpainting techniques in accordance with some aspects of the present disclosure.

FIG. 7A illustrates examples of in-context image pairs used for training the generator model.

FIG. 7B illustrates additional examples of the in-context image pairs for training the generator model.

FIG. 8A illustrates an example of an inference process, demonstrating stages of reverse diffusion iterations.

FIG. 8B illustrates the example of the inference process, demonstrating additional stages of the reverse diffusion iterations.

FIG. 9 illustrates examples of input-output pairs demonstrating inpainting performance of the disclosed techniques.

FIG. 10 illustrates examples from StreetView dataset demonstrating inpainting performance of the disclosed techniques.

FIG. 11 illustrates examples from MegaDepth dataset demonstrating inpainting performance of the disclosed techniques.

FIG. 12 illustrates examples from HM3D dataset demonstrating inpainting performance of the disclosed techniques.

FIG. 13 illustrates examples from WalkingTour dataset demonstrating inpainting performance of the disclosed techniques.

### DETAILED DESCRIPTION

The present disclosure relates to image inpainting techniques leveraging a denoising diffusion probabilistic model (DDPM), also termed herein as generator model that is conditioned on one or more in-context images. The generator model may be trained by introducing noise (e.g. Gaussian, Laplace, Poisson or uniform noise) to a base image in gradual timesteps during a forward diffusion process. The generator model may then learn to denoise the base image in the gradual timesteps by incorporating one or more in-context images to guide the generation process. The base image and the one or more in-context images may depict a same or similar scene captured from multiple perspectives and/or under varying conditions, thereby providing an understanding of the depicted environment. These in-context images may encompass a range of context variations, for example, presence or absence of objects, movements of objects within a frame and/or diverse viewpoints such as perspectives from a height or a distance, thereby facilitating a different visualization of spatial dynamics. Furthermore, variations in time of day, such as mid-day versus night-time, can significantly influence lighting conditions, while alterations in camera angles and camera poses may emphasize specific features or actions within the scene. In addition, in-context images of scenes may include additional images that extend beyond the same or similar scene of the base image such as an object for insertion into the scene.

Once the generator model is trained, the image inpainting may be performed by generating a masked image that obscures one or more portions (e.g., patches or pixels) of an image based on a masking technique. The masking technique may include semantic masking, where specific classes of objects—such as pedestrians or vehicles—are obscured, and random masking, where portions of image are occluded without regard to object type, introducing more complexity in the inpainting task. After masking, the forward diffusion process may be simulated by iteratively adding noise to the masked image until a fully noisy or a noisy image is produced. This fully noisy image may act as a starting point for the subsequent reverse diffusion process that iteratively refines and reconstructs the masked regions based on visual cues from the one or more in-context images by leveraging the trained generator model. Following a noise schedule, the generator model may generate a transformed version of the noisy masked image that represents a denoised and inpainted version, where one or more masked areas are reconstructed to blend seamlessly with the surrounding non-masked regions. Incorporating the in-context images may assist in guiding the inpainting process of a masked image involving significant occluded regions, regardless of the masking technique employed or the diversity of the datasets used.

During the diffusion process, the iterative addition or removal of noise from the image may adhere to the noise schedule, which may define how the noise variance changes over time that spans multiple timesteps e.g., 250, 500 or 1000, thereby controlling the amount of noise added at each timestep. Each timestep may correspond to a specific stage in the diffusion process where a certain amount of noise is added to a latent variable representing an image (e.g., base image for training and masked image for inference). The noise schedule may follow a linear, cosine, exponential or Laplace schedule, determining how quickly or slowly the noise variance increases as the diffusion process progresses. Therefore, the choice of the noise schedule may significantly impact on the performance of the denoising diffusion probabilistic model (DDPM).

In some instances, the noise schedule in a diffusion process can be dynamically adjusted to modulate the number of timesteps during denoising, utilizing importance sampling or other sampling techniques. This dynamic approach may result in introducing sampling jumps in the noise schedule, where specific timesteps receive increased or decreased noise based on evaluation metrics such as peak signal-to-noise ratio (PSNR) and/or the smoothness of intermediate representations. For example, instead of a fixed noise schedule that gradually increases—such as linear or cosine, the noise schedule can change the amount of noise at intermediate timesteps (or sampling jumps) based on assessment criteria. Introducing jumps in the noise schedule may enable targeted adjustments, allowing for better allocation of computational resources such as time for harmonizing the boundaries between masked and non-masked regions. This can improve blending between masked and non-masked regions, enhancing detail capture and reducing artifacts. Additionally, utilizing a Laplace distribution for the noise schedule can provide a more robust noise profile, aiding in the navigation of complex image areas and contributing to higher-quality outputs.

In some aspects, the disclosed techniques may enable the editing of images including inpainting or restoration of images with damaged or missing portions by accurately predicting absent segments. For example, a user may access a set of images via an interface and edit an image by leveraging the context provided by other images in the set, allowing for effective inpainting or restoration of damaged or missing portions. This capability is particularly useful in applications involving art restoration or medical imaging such as MRI or CT scans, where a user can reconstruct corrupted areas or remove unwanted objects by masking these areas using the masking technique and guiding the restoration process by leveraging one or more in-context images that depict the same anatomical region. Additionally, when an image includes unwanted objects, the disclosed techniques may facilitate the removal of these objects by masking the unwanted objects and filling in the occluded areas to enable consistency with the surrounding image.

In the context of perception systems for autonomous vehicles, image inpainting, as described herein, can aid in reconstructing occluded portions of the captured image, thereby enhancing obstacle detection and navigation capabilities. Moreover, the disclosed techniques may be utilized for content generation by processing images with intentionally missing sections or obstructions (e.g., areas exhibiting noise, artifacts, or cropped regions) to create new visual content. This functionality may prove particularly valuable in the advertising and media industries. Similarly, in facial recognition applications, the techniques, as disclosed herein, may reconstruct obscured regions of faces such as those partially covered by hats, hands, or other objects—thereby improving recognition accuracy under challenging conditions.

For image inpainting, the generator model may learn to denoise by performing a cross-view completion task, where the base image is noisy that is to be reconstructed from the visible content provided by the additionally one or more in-context images. In some examples, the noisy image and the one or more in-context images may be segmented independently into equally sized and non-overlapping set of patches for training and passed to the generator model. While in some other examples, non-equally sized and/or overlapping patches may be utilized. Although a different patch size approach may be used but it can complicate the input layer for the generator model. The varying sizes of patches may introduce inconsistencies in the input dimensions, making it challenging for the generator model to effectively learn and generalize patterns across different patch sizes.

In some examples, the generator model may comprise of multiple diffusion vision transformer (DViT) encoders that share weights, along with a single DViT decoder. The number of DViT encoders may be determined by the number of in-context images used to condition the generator model during the reverse diffusion process, with one encoder specifically allocated for processing the noisy image. Since multiple DVIT encoders share weights, suggesting the same set of parameters for each encoder only while processing distinct inputs. Therefore, weight sharing may be alternatively implemented by incorporating one DVIT encoder that learns from distinct inputs such as the noisy image and the one or more in-context images. The DVIT encoder may linearly project each patch of the set of patches into a one-dimensional vector-patch encoding that may be augmented with positional encoding (e.g., learned or sinusoidal positional encoding), enabling the model to recognize the relative positions of different patches within the image for accurate interpretation. Subsequent to patch encoding, a series of one or more encoder-transformers may be employed that may include a multi-head self-attention (MSA) and a multi-layer perceptron (MLP) to generate an encoded representation for the input image (e.g., noisy image or in-context image).

Multi-head self-attention incorporates a self-attention mechanism that may capture relationships among the patches by computing attention scores within the same input image sequence. For each augmented patch encoding associated with each patch, three vectors may be computed: query (Q), key (K), and value (V). The multi-head self-attention uses multiple sets of attention mechanisms (heads) in parallel, where each head learns different aspects such as boundaries, textures, spatial relationships, and/or color compositions among patch tokens (or patches). The number of heads in multi-head self-attention can be chosen based on the task and the model architecture, where each head may represent a different subspace of the patch encodings and can learn to attend to different patches with the image, capturing relationships and features among different patches. The outputs from each head may be concatenated to generate final encoded representation that may be passed to the DVIT decoder.

In some instances, the DVIT decoder may concatenate the outputs from each DVIT encoder via a learnable encoding layer for incorporating multiple encoded representations. The concatenation may generate a unified encoded representation encapsulating information from the noisy image and the corresponding one or more in-context images. The DVIT decoder may pass the unified encoded representation through one or more sequentially connected decoder-transformers, each comprising a multi-head self-attention and an MLP, thereby generating a noisy image as compared to the input noisy image. Alternatively, the DVIT decoder may take encoded representation associated with the noisy image and pass it through the one or more sequentially connected decoder-transformers each comprising the multi-head self-attention, a multi-head cross-attention and the MLP. The multi-head cross attention may compute attention score between patch tokens associated with the noisy image and each of the one or more in-context images. During inference, the generator model may produce iterated versions of the noisy image, each representing a progressively less noisy output compared to the previous input, until it generates the transformed image. The transformed image may represent a clean inpainted image in which masked portions may be coherently and consistently generated with the non-masked portions.

The inpainting performance of the disclosed denoising diffusion probabilistic model-generator model may be quantitatively assessed by various evaluation metrics that assess the quality and effectiveness of the inpainted images compared to the base or ground-truth images. For example, peak signal-to-noise ratio (PSNR) may be used to assess the quality of inpainted image, which quantifies the peak error in decibels (dB), with higher values indicating better quality. Other evaluation metrics may include structural similarity index (SSIM), learned perceptual image patch similarity (LPIPS), mean squared error (MSE), Fréchet inception distance (FID), and/or visual information fidelity (VIF). For qualitative evaluations, mean opinion score (MOS), may also be used, where scores are given by the human evaluators based on visual quality.

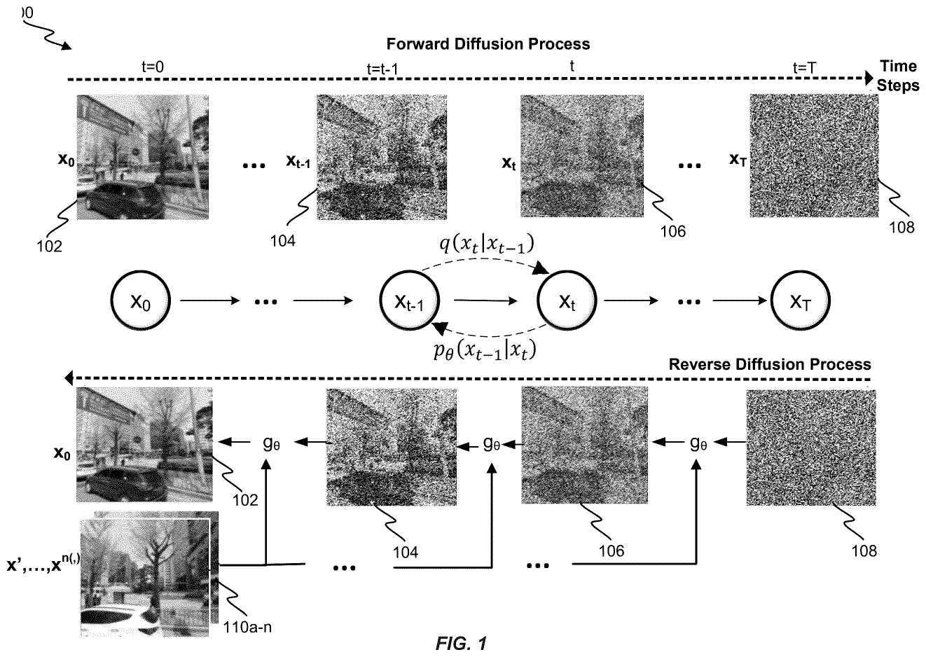

FIG. 1 shows an exemplary block diagram illustrating an aspect of the disclosed image inpainting techniques leveraging one or more in-context images within a diffusion process. Denoising diffusion probabilistic model (DDPM), also termed herein as diffusion models may represent a class of generative modeling that incorporates the diffusion process to generate or synthesize high-quality data samples. The diffusion process may be divided into a forward diffusion process q and reverse diffusion process p. The forward diffusion process may be modeled as a Markov chain in which distribution of real data at a particular timestep depends only on the samples from the previous timesteps. In the forward diffusion, the diffusion model may gradually apply noise to a sample from real data distribution e.g., a base image x₀ 102 from a training dataset, thereby generating a sequence of progressively noisier images x₁, . . . , x_{T}. The distribution of these noisy images can be written as,

$$q ( {x}_{1 : T} \vert {x}_{0} ) = {Π}_{t = 1}^{T} q ( {x}_{t} \vert {x}_{t - 1} ) ,$$

where the subscript denotes the number of timesteps. At each step of Markov chain, noise may be introduced to the latent variables (i.e., representing base image and corresponding noisy images). For example, at timestep t, various types of noise, such as Gaussian, Laplace, or uniform noise may be introduced to xₜ₋₁ 104 producing a new latent variable xₜ 106.

In some aspects of the present disclosure, the noise is sampled from a Gaussian distribution noise, resulting in iterative process of transition (i.e., from xₜ₋₁ 104 to xₜ 106) that may be reshaped as a unimodal Gaussian distribution of the form, q(xₜ|xₜ₋₁)= [symbol] (xₜ; μₜ=\sqrt{1−βₜ}xₜ₋₁, Σₜ=βₜI). Here, βₜ is a hyperparameter that represents variance of the Gaussian distribution, controlling the amount of noise added at each timestep t. Each timestep represents a stage in the process where a certain amount of noise is added to the latent variable. This parameter may follow a predefined noise schedule (e.g., linear or cosine), starting from β₀=0 and progressing to βₜ=1. The choice of the noise schedule may significantly impact on the performance of the model, as it defines discrete steps where a model modifies or adjusts the noise levels during the iterative denoising process. The latent variable xₜ may be directly associated with x₀ by using a reparameterization trick reshaping q(xₜ|xₜ₋₁) as, xₜ˜q(xₜ|x₀)= [symbol] xₜ;μₜ=\sqrt{α̅ₜ}x₀, Σₜ=(1−α̅ₜ)∈ₜ), where ∈ₜ˜ [symbol] (0, I), αₜ=1−βₜ and

$${\overline{α}}_{t} = {Π}_{s = 0}^{T} {α}_{s} .$$

This formulation illustrates the connection between the base latent representation x₀ and its noisy counterpart xₜ, while also emphasizing how the noise schedule, through βₜ and αₜ, may shape the dynamics of the diffusion process.

As T→∞, α̅ₜ→0, the distribution q(x_{T}|x₀)≈ [symbol] (0, I) may lose all information about the base image x₀, generating a full noisy image x_{T} 108. Therefore, in the reverse diffusion process, diffusion models may be designed to generate the base image x₀ by progressively moving from a full noise image x_{T}˜ [symbol] (0, I) to a data distribution through multiple denoising steps x_{T-1}, . . . , x₀. With a small enough (βₜ<<1), the reverse diffusion process may also be modeled as unimodal Gaussian distribution by finding the reverse transitional distribution q(xₜ₋₁|xₜ) for a less noisy image xₜ₋₁ given an intermediate noisy image xₜ as,

$$q ( {x}_{t - 1} \vert {x}_{t} , {x}_{0} ) = 𝒩 ( {x}_{t - 1} ; {μ}_{t} = \frac{\sqrt{{\overline{α}}_{t - 1}} {β}_{t}}{1 - {\overline{α}}_{t}} {x}_{0} + \frac{\sqrt{{\overline{α}}_{t - 1}} {β}_{t}}{1 - {\overline{α}}_{t}} {x}_{t} , \frac{1 - {\overline{α}}_{t - 1}}{1 - {\overline{α}}_{t}} {β}_{t} I )$$

The base image x₀ being unknown during the reverse diffusion process, the distribution q can not be directly computed. Therefore, diffusion models may train a generator model g (e.g., a neural network) with parameters θ to approximate q and predict the parameters μ_{θ}(xₜ, t) of a Gaussian distribution as, g_{θ}(xₜ₋₁|xₜ)= [symbol] (x_{t_1}; μ_{θ}(xₜ, t), Σ_{θ}(xₜ, t)). Similar to the forward diffusion process, the reverse diffusion process may also be modeled as Markov chain. In diffusion models, the forward diffusion process is fixed while the reverse diffusion process may involve learning the parameters of the generator model g_{θ}. Diffusion models can be considered similar to variational autoencoders (VAE), where x₀ is an observed variable and x₁, . . . , x_{T} are latent variables (i.e., z). Therefore, the learning objective may be derived as, log g_{θ}(x)≥E_{q(z|x)}[log g_{θ}(x|z)]−D_{KL}(q(z|x)∥g_{θ}(z)), which is based on the variational lower bound (also known as evidence lower bound, or ELBO) on the marginal log-likelihood log g_{θ}(x) assigned to the observed variable x by the model g_{θ}, where z represents the latent variables. The approximate posterior q(xₜ₋₁|xₜ, x₀) may be sampled iteratively to generate progressively less noisy image. Starting from xₜ (intermediate noisy image) 106, the aim of the generator model may be to generate xₜ₋₁ (less noisy image) 104, gradually moving towards the base image x₀ 102.

In some instances, instead of predicting x₀ 102, cumulative noise E that has been added to the current latent variable xₜ 106 that also represents intermediate noisy image, may be predicted by a generator model g_{θ}. Hence, following parametrization of the predicted mean

$${μ}_{θ} ( {x}_{t} , t ) = \frac{1}{\sqrt{{a}_{t}}} ( {x}_{t} - \frac{{β}_{t}}{\sqrt{1 - {\overline{a}}_{t}}} {g}_{θ} ( {x}_{t} , t ) ) ,$$

training objective may be derived as, L(θ)=E_{t,∈,x}_{₀}∥∈−g_{θ}(xₜ, t)∥². This formulation suggests that given xₜ, if the cumulative noise E that was added to the xₜ is predicted, xₜ₋₁ may be generated. In addition to predicting the mean μ_{θ}(xₜ, t), learning the variance Σ_{θ}(xₜ, t) of the reverse diffusion process can further reduce the number of sampling steps and improve inference time. Alternatively, the training objective may be defined as L(θ)=E_{t,x}_{₀}∥xₜ₋₁−g_{θ}(xₜ, t)∥² in which the generator model g_{θ} may be trained to generate a less noisy xₜ₋₁ 104 image from intermediate noisy image xₜ 106. The training of the generator model may be modified by introducing one or more in-context images e.g., x′, . . . , x^{n(′)} 110a-n for better approximation of the target distribution, thereby improving 3D (three-dimensional) consistency of inpainted images.

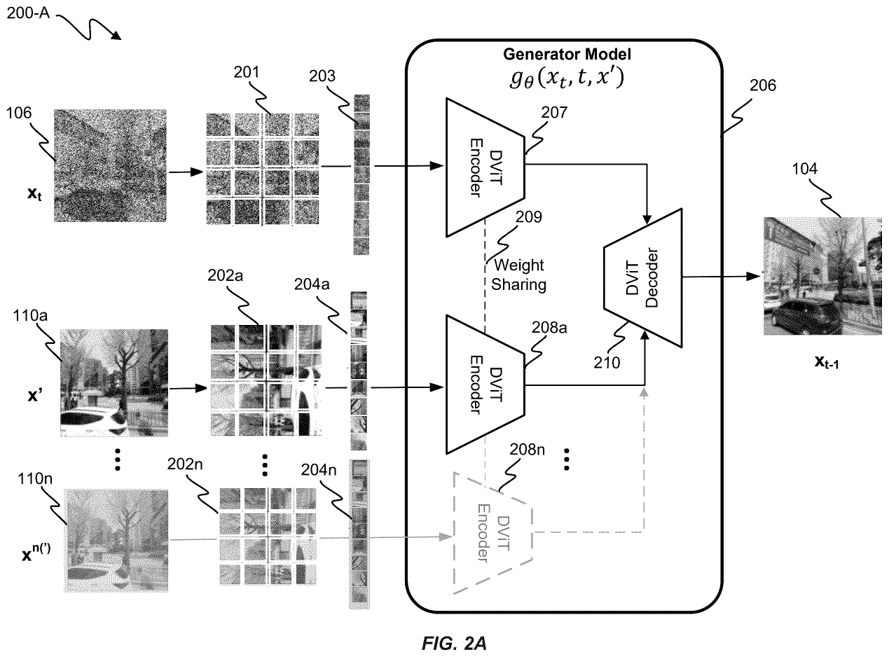

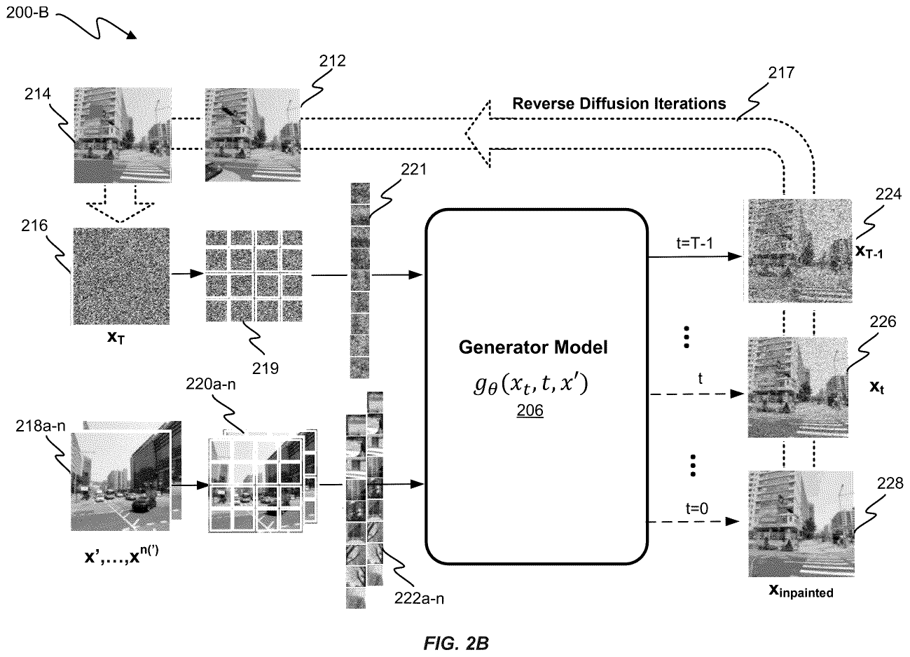

FIG. 2A shows an exemplary network illustrating training process 200-A of a denoising diffusion probabilistic model (DDPM), also termed herein as generator model 206, conditioned on the one or more in-context images 110a-n. Conventional training of the generator model g_{θ}206 in a diffusion process may involve generating denoised images (i.e., less noisy images such as xₜ₋₁ 104) given intermediate noisy images or noisy images (i.e., xₜ 106). By integrating additional in-context images e.g., x′, x″, . . . , x^{n(′)} 110a-n, the training objective may be written as, L(θ)=E_{t,∈,x}_{ₜ}∥∈−g_{θ}(xₜ, t, x′, X″ . . . , x^{n(′)})∥² or alternatively as, L(θ)=E_{t,∈,x}_{₀}∥xₜ−g_{θ}(xₜ, t, x′, x″, . . . , x^{n(′)})∥², where n represents the number of in-context images. Hence, the generator model g_{θ} 206 may be trained from a set of images showing a same or similar scene from different viewpoints. The aim of the generator model 206 may be to perform a cross-view completion task, where the noisy image 106 (i.e. noisy version of base image 102) is to be reconstructed from the visible content of the additional one or more in-context images 110a-n. The noisy image 106 may not be inferred precisely from the image itself, so the generator model 206 may learn to act as a prior influenced by high-level semantics. Alternatively, this ambiguity can be resolved with cross-view completion from one or more in-context images 110a-n that are clean. The generator model 206 may learn to understand the spatial relationship between the noisy image e.g., 106 and in-context images 110a-n for generating less noisy images e.g., 104.

The training process 200-A depicts a set of images: an intermediate noisy image or noisy image xₜ 106 that represents a noisy version of base image x₀ 102 (shown in FIG. 1) and its corresponding in-context images x′ . . . , x^{n(′)} 110a-n. The set of images (i.e., 106 and 110) may represent the same scene captured from multiple distinct time points and/or viewpoints. The in-context images 110a-n may enrich the understanding of the base image x₀ 102 by offering perspectives that may include different poses of a camera (e.g., including angle and/or position of the camera), lighting conditions, or temporal states. For example, in scenarios involving dynamic environments, in-context images can capture the same scene at different times, revealing changes in lighting, shadows, and object positions. The set of images 106 and 110a-n may be segmented individually into sets of patches 201,202a-n that may be equally sized and non-overlapping. Subsequently, the sets of patches from each image may be arranged into sequences of patches 203 and 204a-n that may be processed by a generator model 206. Additionally, the sets of patches 201 and 202a-n may be divided into non-equal sizes or overlapping segments to effectively capture features at various scales and enhance contextual information. However, employing non-equal patches may complicate the input processing, as each patch may require distinct handling.

In some aspects, the generator model g_{θ}(xₜ, t, x′) 206 may comprise of a diffusion vision transformer (DViT) encoder that generates encoded representations by processing the set of patches associated with the noisy image 106. The same DViT encoder may be leveraged to generate the encoded representations by processing the sets of patches associated with the one or more in-context images 110a-n. In FIG. 2A, a series of DViT encoders 207 and 208a-n that share weights and a DViT decoder 210, are shown. Weight sharing 209 may involve using the same parameters across multiple models to improve efficiency, reduce overfitting and maintain consistency in learning. Although multiple DViT encoders 207 and 208a-n are illustrated to represent handling of distinct inputs and outputs, these DViT encoders may represent the same or similar architecture as the weights are the same. This design may enable the DViT encoders process various images (e.g., noisy image and one or more in-context images 110a-n) effectively while leveraging a unified parameter set for better contextual understanding.

Therefore, the sequences of patches e.g., 203 and 204a-n may be encoded using the DViT encoders with shared weights, thus enabling the DViT encoders to learn from the same set of parameters while processing different views of the same scene. The encoded representations from the DViT encoders may be concatenated, creating a unified encoded representation that encapsulates information from multiple perspectives and then fed to the DViT decoder 210 whose goal is to denoise xₜ 106 based on additional context images 110a-n. The DViT decoder 210 may use one or more (or a series of) transformer decoders comprising cross-attention layers. This may enable noise tokens from the intermediate noisy image xₜ 106 to attend clean tokens from the in-context images x′, . . . , x^{n(′)} 110a-n, thus enabling cross-view comparison and reasoning. The generator model 206 may be trained using a pixel reconstruction loss over all patches with the sets of patches 202a-n and 201.

Once the generator model 206 is trained, the image editing or inpainting may be performed at inference within a diffusion process. FIG. 2B illustrates the inference process 200-B that may begin with the preparation of input images that include a masked image 214 obscuring specific regions of an image 212, and one or more in-context images 218a-n that may provide additional visual information about the scene. The in-context images 218a-n may serve to enhance the inpainting process by supplying context that aids in the reconstruction of the masked areas. Following the preparation of inputs, the inpainting process may be initialized by creating a noisy version of the masked image. This may be achieved by introducing noise, simulating the forward diffusion process, for example, a fully noisy version of the masked image 214 or the image 212 may be generated by introducing noise, generating x_{T} 216. The resulting fully noisy image 216 may act as the starting point for the subsequent reverse diffusion process, aimed at iteratively refining and reconstructing the masked regions.

Similar to the training process illustrated in FIG. 2A, the set of images 216 and 218a-n may be preprocessed before feeding into the generator model 206. For example, the fully noisy image 216 and the one or more in-context images 218a-n may be patchified individually into sets of patches 219 and 220a-n, followed by a conversion to sequences of patches 221 and 222a-n. This conversion enables the patches to be compatible with the input layer of the generator model 206.

In some instances, without incorporating one or more in-context images 218a-n, the generator model 206 may condition its generation on the unmasked regions of the masked image during the reverse diffusion iterations 217. This may involve utilizing information from the visible areas to guide the inpainting of the obscured sections. As the reverse diffusion progresses, the generator model 206 may begin with the heavily noisy image (i.e., 216) and gradually denoise it during reverse diffusion iterations 217 generating iterated versions of images x_{T-1}, . . . , xₜ, illustrated by 224, 226 till final transformed or inpainted image x_{inpainted} 228 is generated. At each timestep, an iterated version may be fed back to the generator model 206 during reverse diffusion iteration 217 to generate next iterated version. Predictions for the masked regions are generated based on the contextual cues from the unmasked parts, leveraging the learned patterns from training.

In some other aspects, missing regions of an image defined by a mask region m may be predicted at inference, where the mask along with the one or more in-context images 218a-n may be used to condition the diffusion model-generator model 206. For masking the occlusion classes e.g., pedestrians, vehicle or people, various techniques may be used to mask a patch including at least one pixel of an occlusion class. The masked regions may be denoted as, m└x^{m} and the non-masked (or known) regions may be denoted as, 1−m└x^{k}. Since every reverse diffusion step from xₜ to xₜ₋₁ depends on xₜ, therefore the non-masked regions may be altered as long as properties of the target distribution are maintained. In some instances, when the noise follows a Gaussian distribution—similar to the forward diffusion process characterized by cumulative Gaussian noise—the intermediate noisy image xₜ 106 may be sampled at any point in time using the generator model g_{θ}206. The reverse diffusion step may be defined as,

$$\begin{matrix}{x}_{t - 1}^{n o n - m a s k e d} \approx 𝒩 ( \sqrt{{\hat{α}}_{t}} {x}_{0} , ( 1 - {α}_{t} ) I ) & non - masked regions \\ {x}_{t - 1}^{m a s k e d} \approx 𝒩 ( {μ}_{θ} ( {x}_{t} , t , {x}^{′} , … , {x}^{n ( ′ )} ) , {\sum }_{θ} ( {x}_{t} , t , {x}^{′} , … , {x}^{n ( ′ )} ) ) & masked regions \\ m ⊙ {x}_{t - 1}^{m} + ( 1 - m ) ⊙ {x}_{t - 1}^{k} & combined\end{matrix}$$

Therefore,

$${x}_{t - 1}^{n o n - m a s k e d}$$

may be sampled using the non-masked regions in the image m└x₀, while

$${x}_{t - 1}^{m a s k e d}$$

may be sampled from the generator model g_{θ}, given the previous iteration xₜ and the one or more in-context images x′, . . . , x^{n(′)} 110a-n. Both of these sampled images may be combined to form a new sample xₜ₋₁. The basic noise (or denoising) schedule may be insufficient for harmonizing (or blending) the boundaries between masked and non-masked regions, due to limited flexibility in sampling noise from both regions. To harmonize the masked and non-masked input, a resampling approach may be used in which the output xₜ₋₁ may be adjusted back to xₜ by sampling from the noise distribution defined as, xₜ≈ [symbol] (\sqrt{1−βₜ}xₜ₋₁βₜI). This process may not only scale back the output and introduce noise but also preserve information from the masked region

$${x}_{t - 1}^{m a s k e d}$$

a into the new output

$${x}_{t - 1}^{m a s k e d} ,$$

thereby leading to a new

$${x}_{t - 1}^{m a s k e d}$$

that is both more harmonized with

$${x}_{t - 1}^{n o n - m a s k e d}$$

and include the associated conditional information.

Additionally, by modulating the noise schedule, the generator model 206 may dynamically adjust the amount of noise added at each timestep during the denoising process. This modulation may imply that instead of adhering to a fixed noise schedule—such as linear or cosine—the generator model can change the noise levels based on specific criteria. For instance, it may measure the smoothness of intermediate representations for determining how much noise to add or remove at various stages. This flexible approach may enable the generator model 206 to allocate more computation resources to critical noise levels, improving the blending between masked and non-masked regions thereby enhancing the quality of the transformed or inpainted image 228.

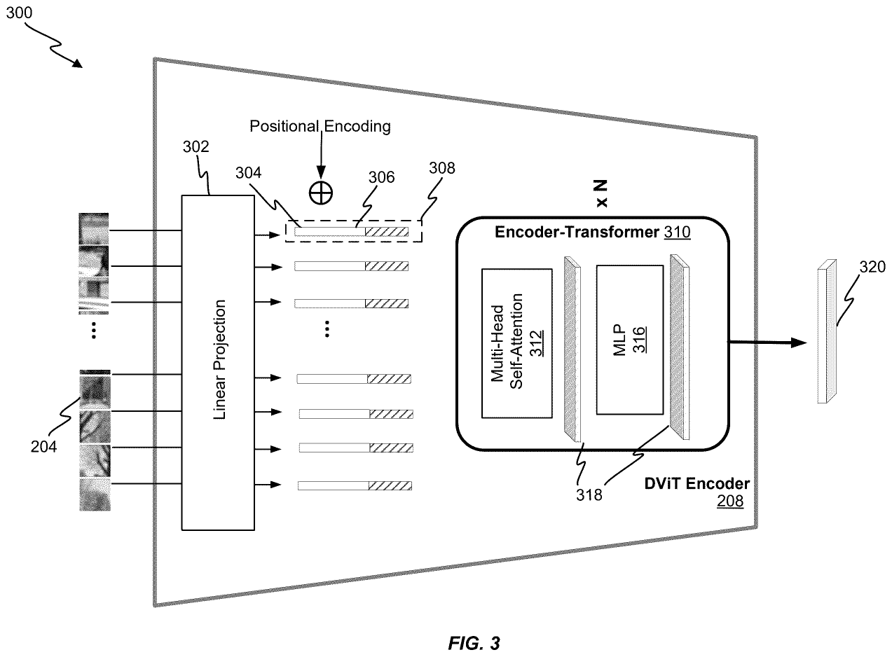

FIG. 3 shows an exemplary block diagram 300 illustrating an instance of a diffusion vision transformer DViT encoder 208 from the FIG. 2A. A typical transformer design processes a one-dimensional (1D) sequence or vector, which is common in natural language processing (NLP). To adapt it for three-dimensional (3D) RGB images, the noisy image xₜ 106 and the associated in-context images 110a-n (both shown in FIG. 1) may be segmented into non-overlapping, equally sized grid of patches 202a and 202b and then reshaped into a sequence of 3D patches 204a and 204b, respectively (as shown in FIG. 2A). The sequence of patches 204a and 204b from both images may be passed independently to the DViT encoders 208a and 208b to generate augmented encoded vectors 308. The DViT encoders 208a and 208b may treat each patch (or token) as an individual entity by passing it to a trainable linear projection 302 that flattens each patch into a 1D vector. The linear projection 302 may further transform the high-dimensional 1D patch into a lower-dimensional vector—patch encoding 304. This transformation may be achieved through a linear operation, such as a fully connected layer with reduced output dimensions. The goal of the dimensionality reduction may be to enhance computational efficiency while retaining relevant information from the input patches.

Since vision transformers (ViT) do not inherently capture spatial information, positional encoding 306 may be added to the patch encoding 304 to preserve the spatial arrangement of the patches. The positional encoding 306 may be incorporated by sinusoidal positional encoding that uses sine and cosine functions to generate continuous position representations that are added to patch encodings 304, allowing the model to understand token positions in a sequence. Other techniques may include learned positional embeddings, which treat positions as trainable parameters; relative positional encoding, which captures the distances between tokens; and rotary positional embeddings, which incorporate position directly into the attention mechanism through rotation. The addition of positional encoding 306 may enable the model to recognize the relative positions of different elements within the image for accurate interpretation. In addition to positional embedding, class tokens (e.g., single or multiple class tokens) may also be incorporated into the augmented encoded vectors 308. This approach may assist in the accurate localization of various objects within a single image. By incorporating class tokens, the model can focus on the regions of the image corresponding to each class, enabling it to generate class-discriminative object localization maps based on the attention between class tokens and patches.

After generating augmented encoded vectors 308, these input tokens 308 may be processed through one or more encoder-transformers 310 (e.g., a total of N blocks). Each encoder-transformer 310 may comprise a multi-head self-attention layer 312, a multi-layer perceptron (MLP) 316 and one or more additional components such as normalization layers 318 and residual connection. Normalization layers 318 may help stabilize training and improve convergence by keeping the activations within a suitable range. Residual connections may facilitate the flow of gradients during backpropagation enabling the model to learn identity mappings more easily. Within these encoder-transformers 310, self-attention is employed to capture relationships among the patch tokens (or patches). In self-attention, attention scores are computed for patch tokens within the same input image sequence. From augmented encoded vectors 308, each patch token generates three vectors: the query (Q), key (K), and value (V).

In self-attention, each patch token may attend to all other patch tokens, enabling the generator model 206 to weigh the relevance in context that in turn captures intricate relationships among patches for enhancing its understanding of the image. The multi-head self-attention (MSA) 312 may refer to a component of the encoder-transformer 310 that uses multiple sets of attention mechanisms (heads) in parallel. Each head learns different aspects such as boundaries, textures, spatial relationships, and color compositions among patch tokens. The number of heads in multi-head self-attention 312 is a hyperparameter that can be chosen based on the task and the model architecture. Each head may represent a different subspace of the patch encodings 304 and can learn to attend to different patches with the image, capturing relationships and features among different patch tokens. The outputs of the different heads are then concatenated and projected to produce the final output, an encoded representation 320, enriching the capability of generator model 206 to capture complex relationships. The DViT encoder 208 may generate the encoded representation 320 from the one or more encoder-transformers 310 connected in series, which may be passed to the DViT decoder 210 for further processing.

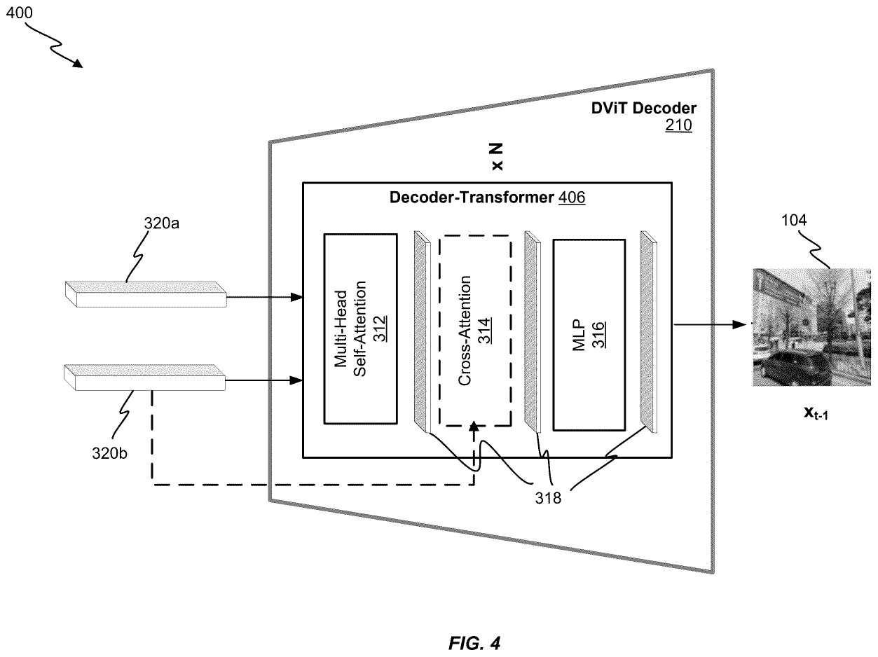

FIG. 4 shows an exemplary block diagram 400 illustrating an instance of a DViT decoder 210 shown in FIG. 2A. The DViT decoder 210 may concatenate the outputs from both encoders i.e., 320a and 320b, creating a unified encoded representation that encapsulates information from both perspectives. In some instances, the DViT decoder 210 may pass the unified encoded representation through one or more decoder-transformers 406 comprising multi-head self-attention 312 and MLP 316. In some other instances, the one or more decoder-transformers 406 may also include a cross-attention layer 314 that involves two different input sequences, where one sequence e.g., 320a serves as the query attending another sequence 320b, which provides the keys and values. This approach is particularly useful in tasks that include interaction between different inputs, as demonstrated in the disclosed techniques, which involve both the noisy image and one or more in-context images. The attention mechanism, whether self or cross, applies a scaled dot-product attention function as

$$A t t ( Q , K , V ) = Soft Max ( \frac{Q {K}^{T}}{\sqrt{f}} ) V$$

to get the attention scores for each input token, where ƒ may denote a scaling factor. The number of heads in multi-head self-attention 312 may affect the dimensionality of the query, key, and value matrices, as well as the output of the self-attention. Typically, this number is a factor of the generator model's dimensionality, with common values being 2, 8, 12, or 16. This multi-head self-attention 312 mechanism may enable the generator model 206 to effectively integrate diverse representations and capture complex relationships within the data.

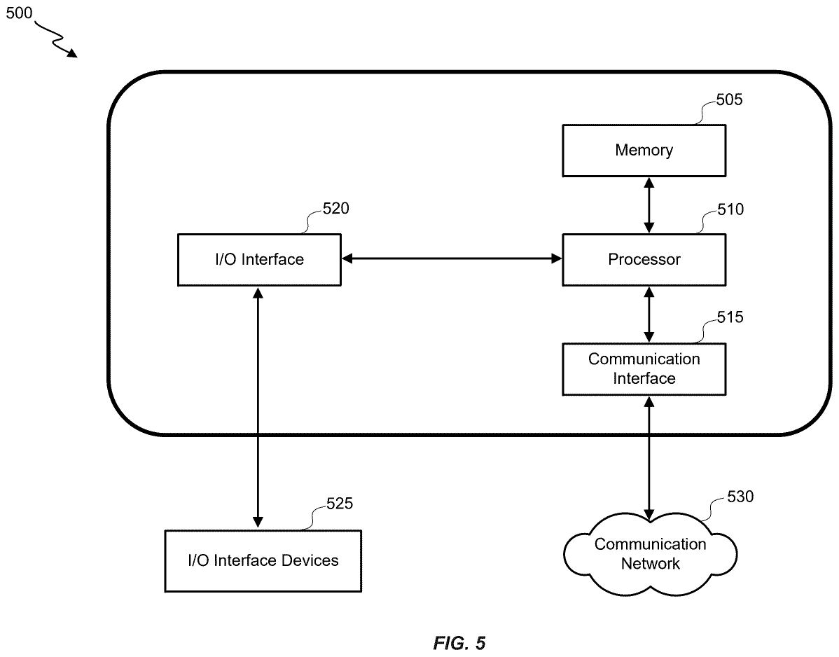

FIG. 5 is a block diagram of an example computing system 500 that may be utilized to perform one or more aspects of the disclosure described herein. For example, in some implementations, the example computing system 500 may be utilized to generate, train, and/or deploy the generator model 206 to perform image editing, including inpainting. The example computing system 500 typically includes at least one processor 510 that communicates with several peripheral devices via buses. These peripheral devices may further include, for example, a memory 505 (e.g., RAM, a magnetic hard disk or an optical storage disk), Input and Output (I/O) interface devices 525 via an I/O interface 520 and a communication network 530 via a communication interface 515.

The I/O interface devices 525 allow user interaction with the example computing system 500. Input interface devices may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into the example computing system 500 or onto the communication network 530. Output interface devices may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the example computing system 500 to the user or to another machine or computing device.

The communication interface 515 provides an interface to the communication networks 530 and is coupled to corresponding interface devices in other computing devices. Some of the examples of the communication interfaces 515 are a modem, digital subscriber line (“DSL”) card, cable modem, network interface card, wireless network card, or other interface device capable of wired, fiber optic, or wireless data communications.

Storage systems store programming and data constructs that provide the functionality of some, or all the modules described herein. These software modules are generally executed by the processor 510 alone or in combination with other processors. The memory 505 used in the example computing system 500 can include several memories including a main random-access memory (RAM) for storage of instructions and data during program execution, a mass storage device that provides persistent storage for program and data files, and may include a hard disk drive, a floppy disk drive along with associated removable media, a CD-ROM drive, a read only memory (ROM) in which fixed instructions are stored, an optical drive, or removable media cartridges. The modules implementing the functionality of certain implementations may be stored in the mass storage system, or in other machines accessible by the processor(s) 510 via the I/O interface 520.

The example computing system 500 can be of varying types including a workstation, server, computing cluster, blade server, server farm, or any other data processing system or computing device. Due to the ever-changing nature of computers and networks, the description of computing system, example 500 depicted in FIG. 5 is intended only as a specific example for purposes of illustrating some implementations. For example, in one embodiment, the computing system 500 operates as described with reference to FIG. 2A for training the generator model 206, and, in another embodiment, the computing system 500 operates as described with reference to FIG. 2B for performing inference using the trained generator model 206. In yet another embodiment, the computing system 500 may both train and perform inference of the generator model 206. Many other configurations of the example computing system 500 are possible having more or fewer components than the computing device depicted in FIG. 5.

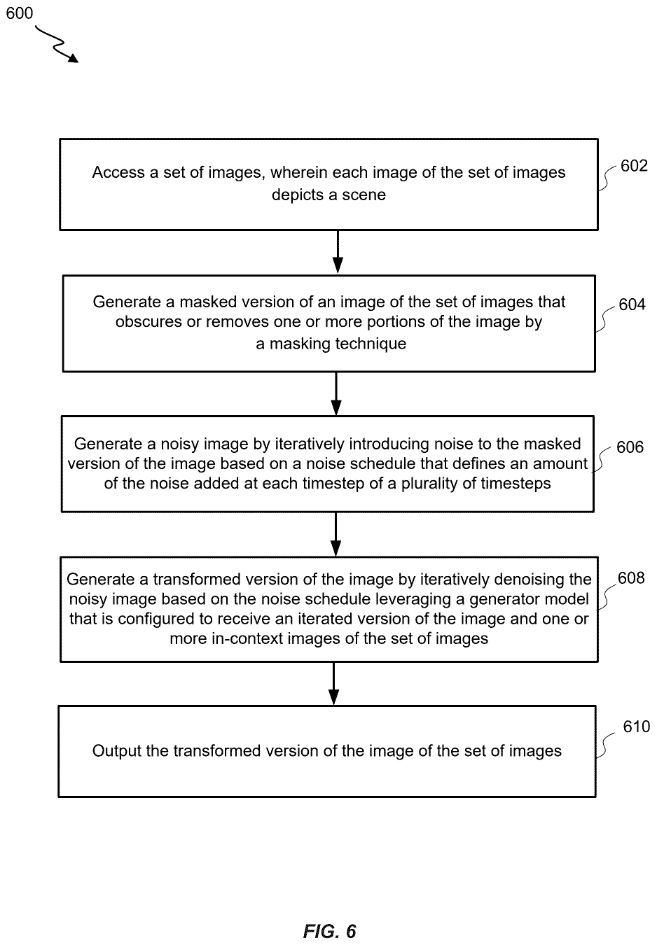

FIG. 6 illustrates an exemplary workflow 600 of the image editing (including inpainting) techniques in accordance with some aspects of the present disclosure referenced in FIGS. 2A and 2B. The blocks in the exemplary workflow 600 are illustrated in a specific order, while the order can be modified, for example, some blocks may be performed before others, and some blocks may be performed simultaneously. The blocks can be performed by hardware, software, or a combination thereof. To perform image inpainting, a generator model 206 may be leveraged that may be conditionally trained on one or more in-context images 110a-n within a diffusion process. The transformer-based generator model, also termed herein as generator model 206, may perform inpainting of an image e.g., 212 at inference that includes accessing a set of images, at block 602. Each image of the set of images may depict a same or similar scene with variation in contexts such as camera poses, camera angles, and/or timestamps. At block 604, a masked version of the image i.e., 214 may be generated by applying a masking technique that obscures or removes one or more portions of the image 212. For example, the masking technique may include random masking including selective occlusion of one or more portions of the image 212 in a random manner or semantic masking that obscures or occludes one or more portions of the image predicted to correspond to predefined classes of objects e.g., table, chairs, sign poles, or vehicles.

After masking, a noisy image e.g., 216 or 226 may be generated, at block 606, by iteratively adding noise to the masked version of the image i.e., 214 based on a noise schedule comprising multiple timesteps. At each timestep, the noise schedule determines an amount of the noise to be added to the masked image 214 to generate a noisier image. For example, the noise may be added to the masked version of the image i.e. 214 in gradual timesteps that are defined by the noise schedule until a fully noisy image e.g., 216 is obtained. In some aspects, the noise may be sampled from a Gaussian noise distribution for generating the noisier image. The fully noisy image 216 may act as a starting point for the subsequent reverse diffusion process that leverages the generator model 206 configured to receive an iterated version of the image (e.g., 224 and 226) and the one or more in-context images (e.g., 228). For example, the generator model 206 may receive an iterated image 224 and may generate a subsequent less noisy image 226 with inpainted regions, where the generation process may be conditioned on the one or more in-context images e.g., 218. Based on the noise schedule, a transformed version of the image 228 may be generated, at block 608, during the reverse diffusion process by iteratively denoising the fully noisy image 216 using the generator model 206. The transformed image or inpainted image 228 may be output, at block 610, depicting a denoised and inpainted version of the base image 102, where the one or more masked portions are reconstructed to align seamlessly with the surrounding non-masked areas.

### Example Implementation

The disclosed inpainting techniques were experimented using one synthetic—Habitat-Matterport (HM3D), and three real-world datasets including MegaDepth, StreetView, and WalkingTour. These datasets provide diverse sources of geometric information regarding scenes and the associated spatial configurations or camera poses that may refer to a specific position and orientation of a camera in 3D space at the time an image is captured. For example, MegaDepth dataset comprises 300,000 images representing various landmarks, each accompanied by a point cloud model generated through structure-form-motion (SfM) using COLMAP (an open-source software for SfM). The point cloud model is a collection of data points in a three-dimensional (3D) coordinate system, typically representing the external surface of an object or scene. The StreetView dataset comprises 350×10⁶ images collected from urban areas in South Korea via Naver maps, provided with associated camera poses, 3D coordinates and recording timestamps. Similarly, the WalkingTour dataset includes 10,000 high-resolution egocentric videos captured in urban settings across Europe and Asia, each depicting an individual navigating through an urban environment. The HM3D is a large dataset featuring 1000 high-resolution synthetic 3D scans of indoor spaces, comprising residential, commercial, and civic environments, all generated from real-world structures. This dataset includes detailed 3D meshes and camera poses, facilitating spatial analysis.

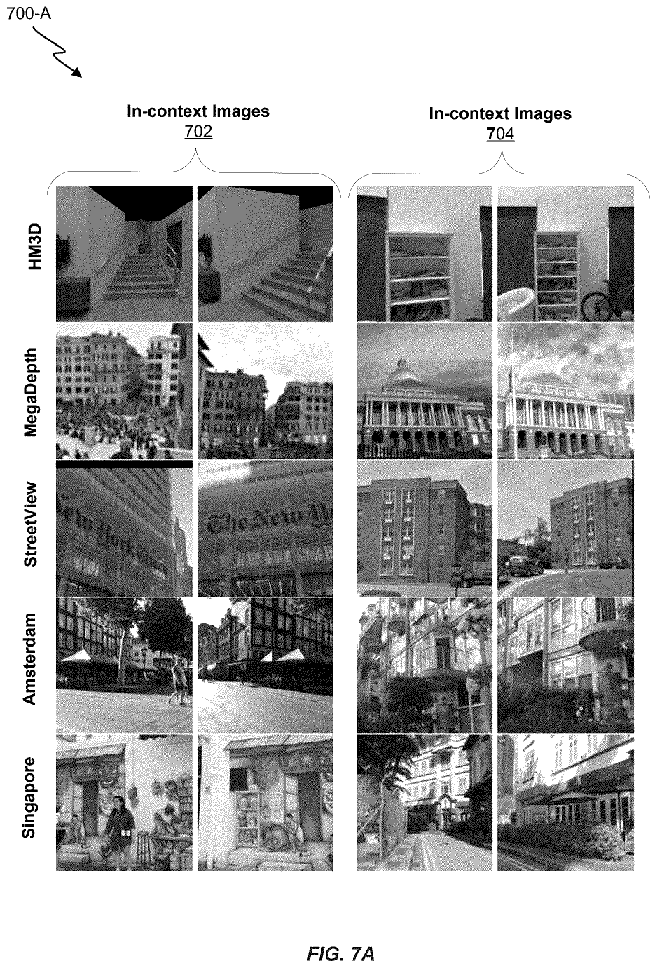

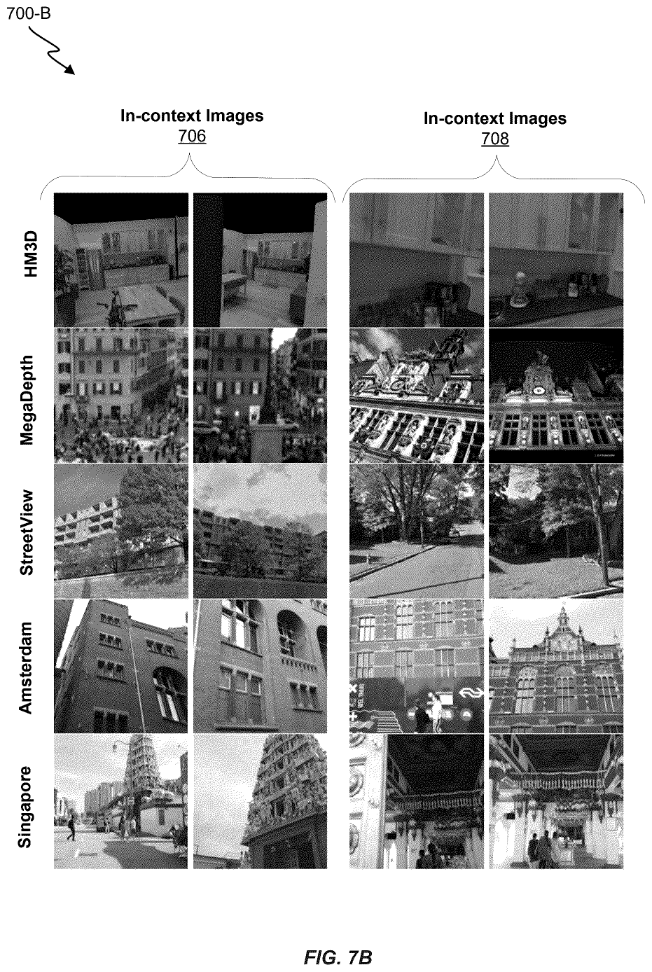

FIG. 7A illustrates examples of in-context image pairs 700-A used for training the denoising diffusion probabilistic model (DDPM)—generator model 206. The FIG. 7A includes multiple rows, each representing a different dataset. Within each row, two pairs of in-context images 702 and 704 are displayed, that vary in context. For example, the pair of in-context images may differ in camera angles capturing how a scene appears from multiple perspectives, as illustrated in in-context images 702 (HM3D and StreetView). The variation in angles may provide a context for the generator model 206 to learn how occluded areas appear from various viewpoints, assisting the generator model 206 to understand spatial relationships and improving its inpainting accuracy. Additionally, variations in camera poses—such as changes in height or distance from the scene, as illustrated in in-context images 704 (Amsterdam, Singapore), may further enhance the contextual richness of the training data. This variability may help the generator model 206 to grasp how the same scene can look different based on the observer's location. These pairs may provide contextual information for training the DDPM to effectively denoise images by learning the underlying distributions of the data.

FIG. 7B illustrates additional examples of in-context image pairs 700-B for training the denoising diffusion probabilistic model (DDPM)—generator model 206. For example, the images may be captured at different times of day or weather conditions, as illustrated in in-context images 708 (MegaDepth), showcasing the effects of varying lighting conditions, shadows, and color tones. This difference in context may introduce variations in lighting and shadows, which can significantly affect the appearance of objects in the scene. By training on images with diverse lighting conditions, the generator model 206 may become more adept at handling real-world scenarios where lighting is inconsistent. Additionally, the inclusion of images that capture dynamic changes within the scene e.g., moving objects or alterations in the background, as illustrated in in-context images 704 (Singapore and MegaDepth), may also enrich the training dataset. This aspect may help the generator model 206 to better understand temporal variations and how they affect the appearance of occluded areas. By incorporating this rich variety of in-context images across different datasets, the inpainting model can effectively learn to restore missing regions, leading to enhanced performance in reconstructing high-quality outputs. It should be understood that in-context image pairs in FIG. 7 are cited to illustrate various contexts. However, some or all forms of contextual variation may be present in these in-context image pairs.

For evaluating performance of image inpainting, various evaluation metrics can be used to assess the quality and effectiveness of the inpainted image in reference to base or ground-truth image. For example, PSNR may represent peak error between the ground-truth image and the inpainted image that may be calculated in decibel (dB), with higher values indicating better quality. Other evaluation metrics may include structural similarity index (SSIM), learned perceptual image patch similarity (LPIPS), mean squared error (MSE), Frechet inception distance (FID), visual information fidelity (VIF) or alternatively, by human evaluation such as mean opinion score (MOS) where humans provide scores on a scale (e.g., 1 to 5 or 1 to 10) based on the visual quality of inpainted images. The SSIM metric measures the similarity between two images (i.e., inpainted and ground-truth), considering luminance, contrast and structure of these images. SSIM ranges from 0 to 1, where 1 indicates a perfect similarity. Similarly, LPIPS is a distance metric that measures perceptual similarity based on deep learning features, where a lower value (e.g., close to 0) indicates that the inpainted image is more visually similar to the ground-truth, while a score closer to 1 indicates large perceptual difference.

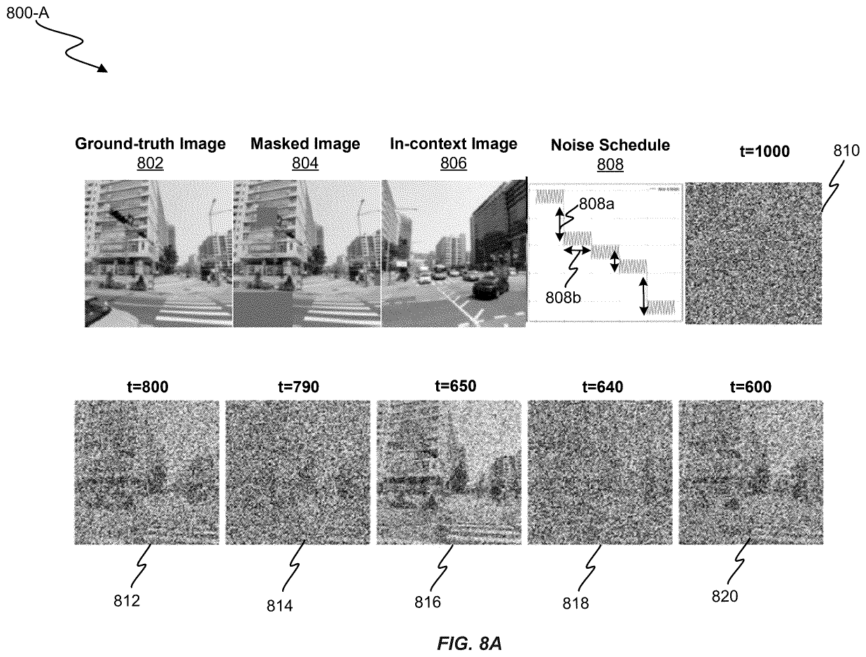

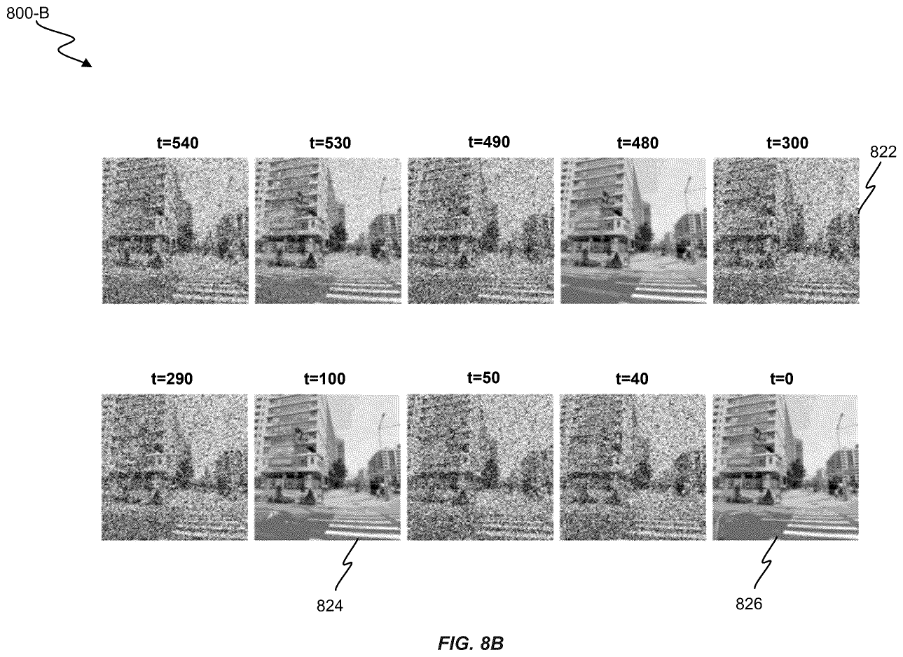

FIG. 8A and FIG. 8B illustrates an example of an inference process 800 of the denoising diffusion probabilistic model (DDPM) or generator model 206, demonstrating various stages of reverse diffusion iterations 217. The FIG. 8A includes a set of images: a base image, interchangeably used herein with a ground-truth image 802, a masked image 804 that occludes (or masks) predefined classes e.g., car and traffic light from the ground-truth image 802 and a corresponding in-context image 806. The inference process starts (e.g., at timestep t=1000) by preparing input that involves adding or introducing Gaussian noise to the masked image 804 resulting in a completely noisy masked image 810, in accordance with a noise schedule 808. The noise schedule 808 may be redefined to prioritize certain noise levels through importance sampling, rather than simply linearly increasing timesteps or adhering to a cosine schedule.

Alternatively, the noise schedule 808 may be defined to dynamically determine the amount of noise to apply at specific timesteps (also referred herein as jumps). While this multi-jump resampling enhances the quality of the output, it may be consequent in additional inference time. To mitigate this, alternative noise schedules may be considered, e.g., modulating the number of jumps based on an analysis of prior performance metrics or predefined criteria e.g., smoothness of intermediate representations. Alternatively, or additionally, Laplace noise schedule may be used, as it may effectively reduce computation overhead while maintaining performance. Through the strategic modulation of the noise schedule, the generator model 206 can dynamically adjust the noise applied at each stage, leading to improved harmonization between masked and non-masked regions and better preservation of image information.

Experimental evaluation and analysis of various noise schedules, including Laplace, Cauchy, and cosine, as well as their shifted and scaled versions, revealed that the implementation of a Laplace noise schedule may significantly enhance computational efficiency. The input pair comprising the noisy masked image 810 and the in-context image 806 may be provided to the generator model 206. During the reverse diffusion process, the generator model 206 may condition its generation on the unmasked image and the in-context image to guide the denoising and inpainting of the obscured sections. As the diffusion progresses, the generator model 206 gradually denoises the noisy masked image 810 e.g., t=790 and t=640 that are illustrated by the corresponding noisy images 814 and 818, respectively.

A higher jump 808a in the noise schedule 808 may be particularly noted at t=790 and t=650, illustrated by the corresponding noisy image 812 and 816. These jumps are followed by gradual timesteps, a relatively smaller jump at t=600, illustrated by the noisy images 820, facilitating boundary harmonization between known and masked segments. It should be understood that for the purpose of illustration few gradual timesteps are depicted; however, there may be more timesteps in between the jumps. FIG. 8B illustrates additional timesteps and notable jumps e.g., at t=300, 100 with corresponding images 822 and 824, respectively during the reverse diffusion process till the reconstruction of masked image 826 at t=0. It may be analyzed from the inference process illustrated in FIG. 8B that the Laplace noise schedule may reduce the overhead associated with multiple sampling from the distribution and minimize the number of intermediate harmonization steps by approximately fifty percent, thereby enhancing the overall performance of the image inpainting process.

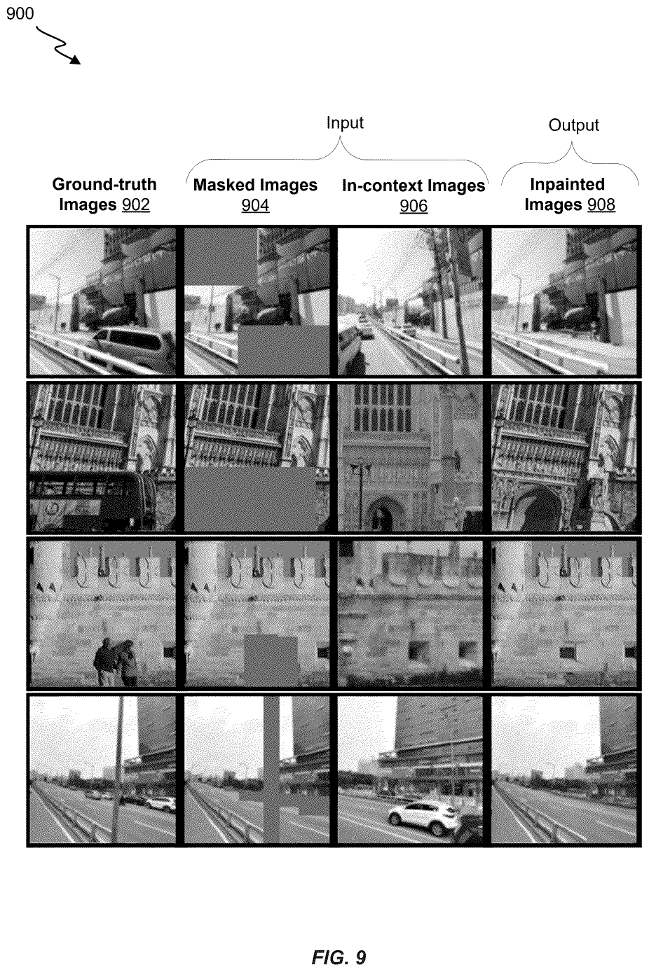

FIG. 9 illustrates examples of input-output pairs 900 demonstrating in-painting performance of the disclosed techniques. Each row corresponds to a set of images: the first column displays ground-truth images 902, while the second column presents the corresponding masked versions 904. Masked images 904 may be generated by initially employing an object detection network (e.g., transformer-based networks such as DINO) to detect specific occlusion classes, such as vehicles, pedestrians, people, poles, wires and traffic lights. Once these classes are identified, the model creates masks for these detected objects, effectively obscuring them in the image. Additionally, any patch that includes at least one pixel belonging to the detected object is also masked for effectively covering the detected object. This approach may provide an effective representation of occlusions within the scene, facilitating subsequent inference tasks, such as inpainting.

Masked images 904 can also be generated using various other techniques. For instance, manual annotation can be employed, where human operators identify and mark regions of interest to be masked, such as objects or occluded areas. Another approach may involve utilizing semantic segmentation algorithms to classify pixels in an image, which can then be used to create masks based on specific object classes. Additionally, generative adversarial networks (GANs) can synthesize masks by learning to differentiate between various objects and backgrounds, enabling the automatic generation of masked images 904 based on learned features. In FIG. 9, the third column features in-context images 906 of the same scene (as of ground-truth) captured from a different time or viewpoint. Together, the masked image 904 and the in-context image 906 form the input pair, representing the same scene with some overlap, is fed into the generator model 206. The fourth column shows the corresponding output as transformed images, interchangeably used herein as inpainted images 908, highlighting the effectiveness of the disclosed techniques in restoring missing or occluded regions.

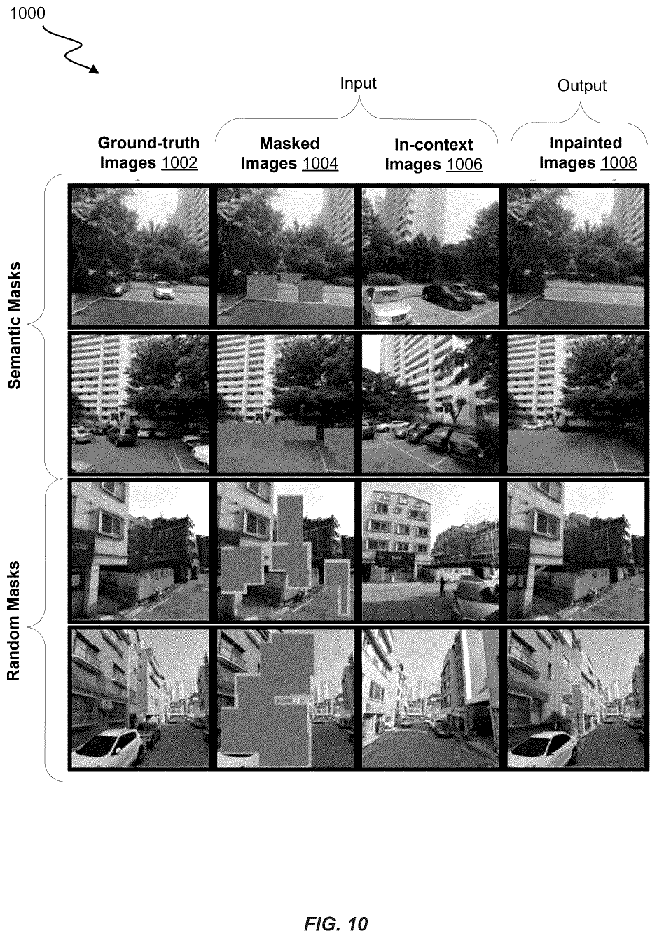

FIG. 10 illustrates examples of input-output pairs 1000 demonstrating inpainting performance of the disclosed techniques for StreetView dataset. In the first column, the ground-truth images 1002 serve as the reference, providing base images for evaluating the inpainting performance. The second and third columns represent the input pairs: the masked images 1004 and the in-context images 1006, respectively. The masked image 1004 highlights specific regions that are obscured, while the in-context image provides additional visual information that aids in the inpainting process. In FIG. 10, the fourth column shows output-inpainted images 1008 corresponding to the input pair. The first two rows utilize semantic masks, where typical representing obstacles such as vehicles, pedestrians, and traffic lights for outdoor scenes are detected and masked. This approach may assist the model to leverage contextual information related to these common obstacle classes, aiming for more accurate and contextually appropriate inpainting results. The last two rows of the FIG. 10 illustrate the results of inpainting using random masks. These randomly generated masks often obscure multiple objects across various locations within the scene, complicating the tasks of boundary harmonization and maintaining 3D consistency. The random mask generation process may involve creating a union of multiple rectangles (e.g., k=10), with the total masked ratio varying between 30% and 50% of the image size, averaging around 40%. This random masking strategy may introduce additional challenges, as it may require the generator model 206 to reconstruct not only individual objects but also the overall scene coherence.

The evaluation studies demonstrate the robustness of the disclosed inpainting techniques across increasing average mask ratios, showcasing its ability to handle cases where up to 50% or even 60% of the image is obscured. This analysis may highlight the effectiveness of the disclosed techniques in both semantically defined and random masking, underscoring their potential for practical applications in image inpainting and restoring tasks. Additionally, a performance comparison of the disclosed inpainting techniques is performed with existing state-of-the-art (SOTA) inpainting techniques, including RePaint (inpainting using denoising diffusion probabilistic models), Stable Diffusion (SD) and Stable Diffusion SD-XL. Stable Diffusion (SD) is a generative model that utilizes a diffusion process to create images from text prompts, capable of inpainting by filling in masked regions based on surrounding context. In contrast, SD-XL is an improved version of Stable Diffusion that offers improvements in terms of image quality, resolution, and contextual understanding. Both models serve as benchmarks for evaluating the performance of our inpainting techniques.

TABLE 1
Evaluation results on StreetView dataset.

| | Semantic Mask | | | Random Mask | | |
|---|---|---|---|---|---|---|
| Method | PSNR↑ | LPIPS↓ | SSIM↑ | PSNR↑ | LPIPS↓ | SSIM↑ |
| RePaint | 17.92 | 0.30 | 0.81 | 17.16 | 0.34 | — |
| SD | 21.57 | 0.17 | 0.90 | 22.39 | 0.19 | 0.84 |
| SD-XL | 22.56 | 0.14 | 0.91 | 22.60 | 0.17 | 0.84 |
| InCo-Diff (disclosed) | 23.62 | 0.09 | 0.90 | 23.19 | 0.11 | 0.83 |

TABLE 1 presents the evaluation results of existing state-of-the-art (SOTA) techniques compared to the disclosed inpainting techniques, focusing on the metrics of PSNR, LPIPS, and SSIM for both semantic and random masks on the StreetView dataset. The performance of the generator model 206 trained in accordance with some aspects of the disclosed techniques is emphasized in bold in TABLE 1 and termed herein as, InCo-Diff (In-Context Diffusion). The arrows next to the labels in all the tables below refer to the indication of direction in which the value of the respective evaluation metric should be e.g., an up arrow (↑) suggest the more the better and a down arrow (↓) suggests the lesser the better. The findings in TABLE 1 indicate that the techniques presented herein surpass the SOTA methods in image inpainting and restoration tasks, demonstrating their superior effectiveness.

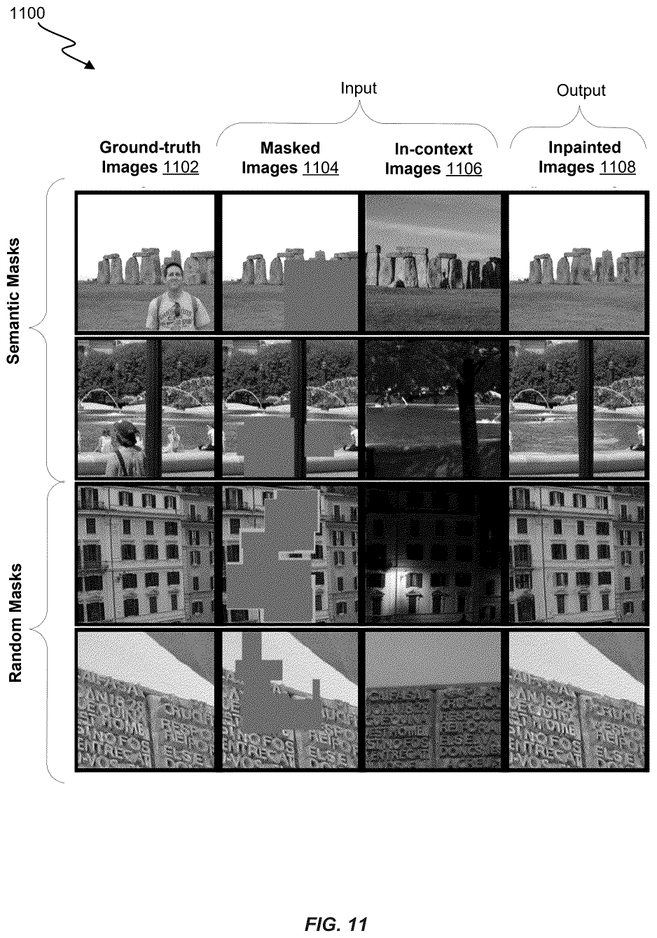

FIG. 11 illustrates examples of input-output pairs 1100 demonstrating inpainting performance of the disclosed techniques for MegaDepth dataset. The first column presents ground-truth images 1102, which serve as a reference or base for masking and evaluating inpainting performance. The second and third columns depict the input pairs: masked images 1104 and in-context images 1106, respectively. The masked images 1104 highlight specific regions that are obscured, particularly focusing on individuals (i.e., persons or people), while the in-context images provide supplementary visual information that aids the inpainting process. The fourth column shows the output inpainted images 1108 corresponding to the input pairs. The first two rows utilize semantic masks, where typical obstacles, such as individuals, are detected and masked. This method enables the model to leverage contextual information associated with these classes, enhancing the accuracy and contextual relevance of the inpainting results. The last two rows of FIG. 11 exhibit the results of inpainting using random masks, showcasing the versatility of the disclosed inpainting techniques in handling various masking scenarios.

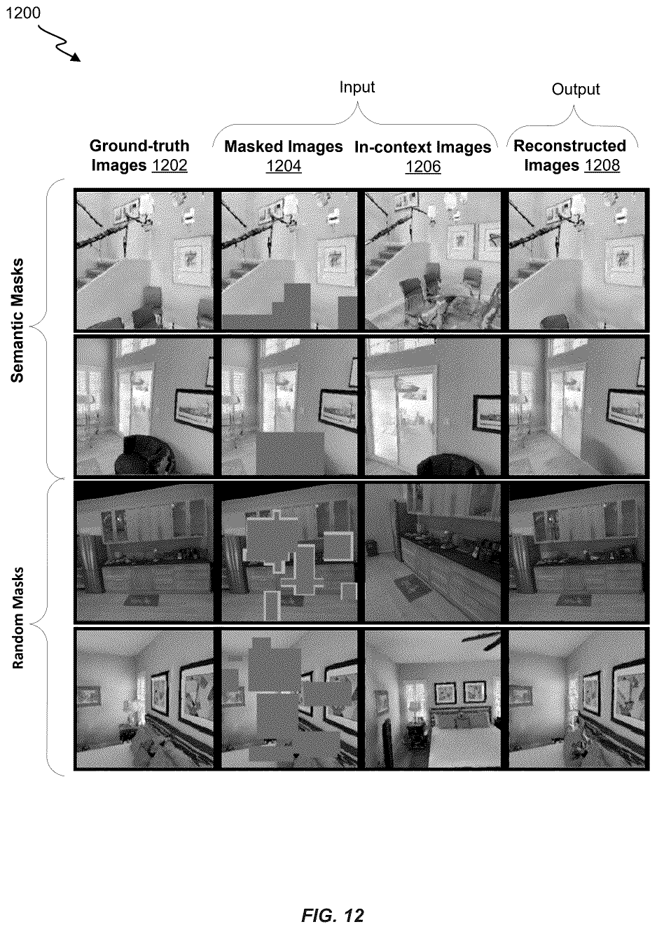

FIG. 12 illustrates examples of input-output pairs 1200 demonstrating inpainting performance of the disclosed techniques for HM3D dataset. Each example shows the ability of the generator model 206 to reconstruct obscured areas from the indoor scenes effectively. The inputs include masked images 1204, where specific regions are masked semantically (e.g., for typical classes such as chair, table) or randomly, alongside their corresponding in-context images 1206, which provide visual cues. The outputs reveal the inpainted images 1208, illustrating how the generator model 206, trained in accordance with some aspects of the present disclosure, successfully integrates contextual information to restore missing details. The FIG. 12 underscores the robustness of the proposed methods for indoor scenes, demonstrating their applicability across diverse scenarios including indoor and outdoor settings.

TABLE 2
Evaluation results on MegaDepth dataset.

| | Semantic Mask | | | Random Mask | | |
|---|---|---|---|---|---|---|
| Method | PSNR↑ | LPIPS↓ | SSIM↑ | PSNR↑ | LPIPS↓ | SSIM↑ |
| RePaint | 20.73 | 0.34 | 0.87 | — | — | — |
| SD | 23.10 | 0.21 | 0.88 | 22.96 | 0.19 | 0.84 |
| SD-XL | 23.11 | 0.15 | 0.88 | 23.14 | 0.15 | 0.84 |
| InCo-Diff (disclosed) | 23.39 | 0.12 | 0.86 | 23.19 | 0.12 | 0.83 |

TABLE 2 and TABLE 3 quantitatively present the improvements in evaluation metrics for image inpainting on the MegaDepth dataset and HM3D dataset, respectively, achieved by the disclosed techniques. The InCo-Diff, representing the generator model 206 trained in accordance with some aspects of the disclosed techniques, is also compared to existing state-of-the-art (SOTA) methods for both semantic and random masks. The performance of the InCo-Diff is highlighted in bold, underscoring its effectiveness in enhancing image inpainting outcomes.

TABLE 1
Evaluation results on HM3D dataset.

| | Semantic Mask | | | Random Mask | | |
|---|---|---|---|---|---|---|
| Method | PSNR↑ | LPIPS↓ | SSIM↑ | PSNR↑ | LPIPS↓ | SSIM↑ |
| RePaint | — | — | — | 18.87 | 0.35 | 0.82 |
| SD | 22.02 | 0.19 | 0.89 | 24.32 | 0.19 | 0.89 |
| SD-XL | 22.91 | 0.14 | 0.89 | 23.33 | 0.14 | 0.89 |
| InCo-Diff (disclosed) | 23.34 | 0.09 | 0.90 | 26.43 | 0.10 | 0.90 |

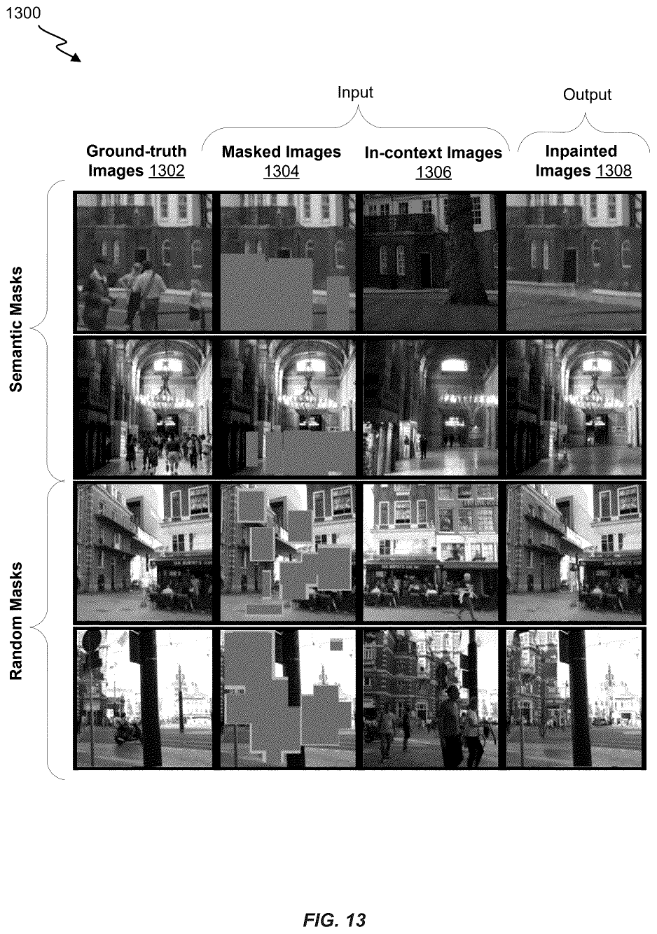

FIG. 13 illustrates examples of input-output pairs 1300 demonstrating inpainting performance of the disclosed techniques for WalkingTour dataset. In this dataset, the ground-truth images 1302 are shown in the first column, capturing urban settings across Europe and Asia, with each image depicting individuals navigating through urban environments. The obscured classes primarily include people walking around, therefore, the masked images 1304 occlude these detected individuals using semantic masking. For the random masking, approximately 40-60% of the image area is randomly occluded. The inpainted images 1308 show the effectiveness of the disclosed inpainting process, suggesting that one or more additional viewpoints or in-context images 1306 provide valuable guidance. This contextual information may enhance the realism and consistency of the inpainted regions by incorporating 3D priors (or the in-context images 1306) into the reconstruction.

TABLE 4 shows the quantitative analysis of the InCo-Diff, in terms of evaluation metrics for WalkingTour dataset including four difference scenes. The performance of the In-CoDiff is also compared with state-of-the-art (SOTA) inpainting techniques for different masking techniques i.e., ransom masking and semantic masking. The findings in TABLE 4 further confirm the effectiveness of the disclosed inpainting techniques that regardless of the variations in the environmental setting, the disclosed techniques generate consistent and semantically coherent inpainted images.

TABLE 2
Evaluation results on four scenes from WalkingTour dataset.

| | Scene | | | | | | | | | | | |
|---|---|---|---|---|---|---|---|---|---|---|---|---|
| | Amsterdam | | | Istanbul | | | Zurich | | | Stockholm | | |
| Method | PSNR↑ | LPIPS↓ | SSIM↑ | PSNR↑ | LPIPS↓ | SSIM↑ | PSNR↑ | LPIPS↓ | SSIM↑ | PSNR↑ | LPIPS↓ | SSIM↑ |

Semantic Mask

| | | | | | | | | | | | | |
|---|---|---|---|---|---|---|---|---|---|---|---|---|
| RePaint | 10.87 | 0.56 | 0.85 | 10.17 | 0.59 | 0.78 | 11.48 | 0.53 | 0.89 | 12.22 | 0.51 | 0.86 |
| SD | 14.09 | 0.54 | 0.84 | 14.64 | 0.23 | 0.77 | 15.14 | 0.21 | 0.90 | 17.41 | 0.16 | 0.85 |
| SD-XL | 14.03 | 0.24 | 0.84 | 13.69 | 0.24 | 0.78 | 15.17 | 0.22 | 0.90 | 17.49 | 0.16 | 0.86 |
| InCo-Diff | 19.96 | 0.09 | 0.89 | 17.30 | 0.13 | 0.83 | 21.75 | 0.06 | 0.93 | 19.70 | 0.09 | 0.89 |

Random Mask

| | | | | | | | | | | | | |
|---|---|---|---|---|---|---|---|---|---|---|---|---|
| RePaint | 10.68 | 0.60 | 0.70 | 10.39 | 0.60 | 0.70 | 11.19 | 0.58 | 0.71 | 12.37 | 0.55 | 0.72 |
| SD | 14.98 | 0.32 | 0.70 | 16.68 | 0.26 | 0.70 | 19.87 | 0.19 | 0.72 | 14.75 | 0.18 | 0.73 |
| SD-XL | 14.06 | 0.24 | 0.71 | 17.75 | 0.23 | 0.71 | 20.07 | 0.18 | 0.73 | 14.86 | 0.18 | 0.74 |
| InCo-Diff | 21.36 | 0.08 | 0.87 | 20.59 | 0.09 | 0.85 | 23.01 | 0.06 | 0.93 | 21.42 | 0.09 | 0.87 |

TABLE 5 ablates the average mask ratio by running InCo-Diff techniques and SD-XL inpainting on MegaDepth dataset, with additional masking values 0.3, 0.4, 0.5, 0.6 and 0.7. As the table shows, the disclosed techniques resist better than SD-XL to the larger random mask ratio, and benefit from the in-context images to fill in the masked segments.

TABLE 3
Ablation on the average masking ratio for MegaDepth dataset.

| | InCo-Diff | | | SD-XL | | |
|---|---|---|---|---|---|---|
| Mask ratio | PSNR↑ | LPIPS↓ | SSIM↑ | PSNR↑ | LPIPS↓ | SSIM↑ |
| 0.3 | 24.53 | 0.09 | 0.89 | 24.47 | 0.12 | 0.89 |
| 0.4 | 24.16 | 0.10 | 0.86 | 24.14 | 0.15 | 0.84 |
| 0.5 | 24.02 | 0.11 | 0.84 | 22.08 | 0.18 | 0.80 |
| 0.6 | 23.73 | 0.13 | 0.82 | 21.08 | 0.20 | 0.76 |
| 0.7 | 23.41 | 0.13 | 0.81 | 20.29 | 0.23 | 0.74 |

TABLE 6 lists the evaluation results for analyzing the impact of varying timesteps and number of jumps in the noise schedule for HM3D dataset. For example, the number of timesteps are set as 250, 500, and 1000, while the number of jumps is varied as 1, 5, and 10. It can be observed that decreasing the number of timesteps may lead to faster inpainting; however, this acceleration may come at the cost of a slight performance drop in terms of evaluation metrics such as PSNR, LPIPS and SSIM. Additionally, fewer timesteps may restrict the ability of the generator model to effectively capture the complexity of the underlying data distribution and exploration of the noise space, potentially leading to artifacts or less accurate reconstructions. Similarly, increasing the number of jumps can enhance the quality of the output by allowing for more computational resources to be allocated to critical noise levels. This increased granularity may enable better blending between masked and non-masked regions, resulting in more coherent and visually pleasing inpainted results. Although this approach may lead to additional inference time, the resulting improvements in output quality can significantly outweigh the computational costs, particularly in applications where visual fidelity is a concern.

TABLE 4
Evaluation results on schedule steps and jumps on HM3D dataset.

| | Number of Timesteps | | | | | | | | |
|---|---|---|---|---|---|---|---|---|---|
| | 250 | | | 500 | | | 1000 | | |
| | Number of Jumps | | | | | | | | |
| | 1 | 5 | 10 | 1 | 5 | 10 | 1 | 5 | 10 |
| SSIM ↑ | 0.83 | 0.89 | 0.91 | 0.83 | 0.90 | 0.91 | 0.83 | 0.88 | 0.91 |
| LPIPS ↓ | 0.26 | 0.12 | 0.10 | 0.26 | 0.11 | 0.09 | 0.26 | 0.11 | 0.09 |
| PSNR ↑ | 18.7 | 23.2 | 24.1 | 18.7 | 23.7 | 25.1 | 18.7 | 23.7 | 25.1 |

Although specific aspects have been described, various modifications, alterations, alternative constructions, and equivalents are possible. Embodiments are not restricted to operation within certain specific data processing environments but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation, such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and 1 other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method for image editing including:
accessing a set of images, wherein each image of the set of images depicts a scene;
generating a masked version of an image of the set of images that obscures or removes one or more portions of the image by a masking technique;
at each timestep of a plurality of timesteps:
generating a noisy image by introducing noise to the masked version of the image based on a noise schedule that defines an amount of the noise added at each timestep of the plurality of timesteps; and
generating a transformed version of the image by denoising the noisy image based on the noise schedule leveraging a generator model, wherein the generator model is configured to receive an iterated version of the image and one or more in-context images of the set of images, and wherein the one or more portions of the masked version of the image are iteratively transformed by the generator model using the one or more in-context images of the set of images; and
outputting the transformed version of the image.

2. The computer-implemented method of claim 1, further including:
segmenting each image of the set of images independently into a set of patches that are equally sized and non-overlapping.

3. The computer-implemented method of claim 1, wherein the generator model including:
an encoder comprising one or more encoder-transformers, including a self-attention layer, configured to generate an encoded representation by processing a set of patches associated with the noisy image and to simultaneously generate one or more encoded representations by processing one or more sets of patches associated with the one or more in-context images, wherein the encoder shares weights across the noisy image and the one or more in-context images; and
a decoder comprising one or more decoder-transformers, including the self-attention layer and a cross-attention layer, configured to process the encoded representation and the one or more encoded representations to generate the iterated version of the image.

4. The computer-implemented method of claim 1, wherein the masking technique includes random masking or semantic masking that obscures the one or more portions of the image that are predicted to correspond to any of one or more types of predefined depictions.

5. The computer-implemented method of claim 1, wherein the noise schedule modulates a frequency of timesteps of the plurality of timesteps during the denoising, based on an importance sampling technique that dynamically determines the amount of noise to introduce at specific timesteps of the plurality of timesteps based on predefined criteria involving the iterated version of the image.

6. The computer-implemented method of claim 1, wherein the noise schedule is generated from a Laplace distribution.

7. The computer-implemented method of claim 1, wherein the noise that is iteratively introduced to the masked version of the image has a Gaussian distribution.

8. The computer-implemented method of claim 1, wherein the scene of the masked version of the image is the same as the one or more in-context images of the set of images.

9. The computer-implemented method of claim 1, wherein the generator model is conditionally trained on one or more in-context images during a reverse diffusion process to generate a less noisy image of an intermediate noisy image.

10. The computer-implemented method of claim 1, wherein the method includes inpainting and, wherein the one or more portions of the masked version of the image are transformed by being reconstructed by the generator model using the one or more in-context images of the set of images.

11. The computer-implemented method of claim 1, wherein accessing the set of images is in response to a user input and, wherein outputting the transformed version of the image is to a display of a computing system.

12. A system comprising:
one or more data processors; and
a non-transitory computer readable storage medium containing instruction which, when executed on the one or more data processors, cause the one or more data processors to perform a set of operations including:
accessing a set of images, wherein each image of the set of images depicts a scene;
generating a masked version of an image of the set of images that obscures or removes one or more portions of the image by a masking technique;
at each timestep of a plurality of timesteps:
generating a noisy image by introducing noise to the masked version of the image based on a noise schedule that defines an amount of the noise added at each timestep of the plurality of timesteps; and
generating a transformed version of the image by denoising the noisy image based on the noise schedule leveraging a generator model, wherein the generator model is configured to receive an iterated version of the image and one or more in-context images of the set of images, and wherein the one or more portions of the masked version of the image are iteratively transformed by the generator model using the one or more in-context images of the set of images; and
outputting the transformed version of the image.

13. The system of claim 12, wherein the set of operations further includes:
segmenting each image of the set of images into a set of patches that are equally sized and non-overlapping.

14. The system of claim 12, wherein the generator model includes:
an encoder comprising one or more encoder-transformers, including a self-attention layer, configured to generate an encoded representation by processing a set of patches associated with the noisy image and to simultaneously generate one or more encoded representations by processing sets of patches associated with the one or more in-context images, wherein the encoder shares weights across the noisy image and the one or more in-context images; and
a decoder comprising one or more decoder-transformers, including the self-attention layer and a cross-attention layer, configured to process the encoded representation and the one or more encoded representations to generate the iterated version of the image.

15. The system of claim 12, wherein the masking technique includes random masking or semantic masking that obscures the one or more portions of the image that are predicted to correspond to any of one or more types of predefined depictions.

16. The system of claim 12, wherein the noise schedule modulates a frequency of timesteps of the plurality of timesteps during the denoising, based on an importance sampling technique that dynamically determines the amount of noise to be introduced at specific timesteps of the plurality of timesteps based on predefined criteria involving the iterated version of the image and, wherein the noise schedule is generated from a Laplace distribution.

17. The system of claim 12, wherein the noise has a Gaussian distribution.

18. A computer-program product tangibly embodied in a non-transitory machine readable storage medium, including instructions configured to cause one or more data processors to perform to perform a set of operations comprising:
accessing a set of images, wherein each image of the set of images depicts a scene;
generating a masked version of an image of the set of images that obscures or removes one or more portions of the image by a masking technique;
at each timestep of a plurality of timesteps:
generating a noisy image by introducing noise to the masked version of the image based on a noise schedule that defines an amount of the noise added at each timestep of the plurality of timesteps; and
generating a transformed version of the image by denoising the noisy image based on the noise schedule leveraging a generator model, wherein the generator model is configured to receive an iterated version of the image and one or more in-context images of the set of images, and wherein the one or more portions of the masked version of the image are iteratively transformed by the generator model using the one or more in-context images of the set of images; and
outputting the transformed version of the image.

19. The computer-program product of claim 18, wherein the generator model includes:
an encoder comprising one or more encoder-transformers, including a self-attention layer, configured to generate an encoded representation by processing a set of patches associated with the noisy image and to simultaneously generate one or more encoded representations by processing sets of patches associated with the one or more in-context images, wherein the encoder shares weights across the noisy image and the one or more in-context images; and
a decoder comprising a series of decoder-transformers, including the self-attention layer and a cross-attention layer, configured to process the encoded representation and the one or more encoded representations to generate the iterated version of the image.

20. The computer-program product of claim 18, wherein the noise schedule modulates a frequency of timesteps of the plurality of timesteps during the denoising, based on an importance sampling technique that dynamically determines the amount of noise to introduce at specific timesteps of the plurality of timesteps based on predefined criteria involving the iterated version of the image, and wherein the noise schedule is generated from a Laplace distribution.
